(19) United States
(12) Patent Application Publication
(10) Pub. No.: US 2016/0086068 A1
(43) Pub. Date: Mar. 24, 2016

(54) PRINT CONTROL APPARATUS, PRINT CONTROL METHOD, AND PROGRAM

(71) Applicant: CANON KABUSHIKI KAISHA, Tokyo (JP)

(72) Inventor: Sho Nakamura, Tokyo (JP)

(21) Appl. No.: 14/855,256

(22) Filed: Sep. 15, 2015

(30) Foreign Application Priority Data
Sep. 18, 2014 (JP) 2014-190117

(51) Int. Cl. G06K 15/00; G06K 15/02

(52) U.S. Cl. CPC G06K 15/403; G06K 15/1868

(57) ABSTRACT

A print control apparatus includes a generation unit that generates pieces of image data based on pieces of print data of a plurality of pages, a first determination unit that, each time the generation unit generates image data of a target page based on print data of the target page, determines whether a print condition of the target page satisfies a predetermined print condition, a setting unit that, based on a result of the determination performed by the first determination unit, sets a discharge destination of sheets on which images based on pieces of image data of a predetermined number of pages including the target page are printed, and a print control unit that causes a print unit to print an image based on image data generated by the generation unit.

### BACKGROUND

1. Field

Aspects of the present invention generally relate to a print control apparatus, a print control method, and a program which can discharge printed sheets to a plurality of discharge destinations.

2. Description of the Related Art

Printing apparatuses that discharge recording sheets formed by an image forming unit to a plurality of trays are known. A method of determining a tray for each page in a job in which a sheet of special size or type dischargeable only to a specific tray and the other sheets are mixed has been proposed (Japanese Patent Laid-Open No. 2005-66996). When printing is performed after image processing has been performed upon all pages in a job in which a special sheet and the other sheets are mixed and then pieces of print data of the pages have been generated, the sizes of all pages and sheet information about all pages can be obtained before the printing. It is therefore determined whether there is a special sheet in a job before printing. When it is determined that there is a special sheet, all sheets in the job are discharged to a specific tray. On the other hand, when printing is started after one page in an input job has been subjected to image processing and print data of the page has been generated, it cannot be determined whether there is a special sheet in all pages in the job. Accordingly, each time the print data of one page is generated, it is determined whether the page is a special sheet. When it is determined that the page is a special sheet, pages following the page are discharged to a specific tray.

Referring to Japanese Patent Laid-Open No. 2005-66996, in a case where, each time print data of one page is generated, it is determined whether the page is special sheet, a page that has already been determined not to be a special sheet and been printed is in a tray different from a specific tray. In the case of a job in the middle of which there is a page to be printed on a special sheet, all pages in the job cannot be discharged to the same tray. In a case where all pages in a job are discharged to the same tray without fail, pieces of print data of all pages are generated and then the determination of whether there is a special sheet is performed. Since the pieces of print data of all pages are needed, a print start time is delayed.

### SUMMARY

A print control apparatus according to an embodiment of the present invention includes a generation unit configured to generate pieces of image data based on pieces of print data of a plurality of pages, a first determination unit configured to, each time the generation unit generates image data of a target page based on print data of the target page, determine whether a print condition of the target page satisfies a predetermined print condition, a setting unit configured to, based on a result of the determination performed by the first determination unit, set a discharge destination of sheets on which images based on pieces of image data of a predetermined number of pages including the target page are printed from among discharge destinations, and a print control unit configured to cause a print unit to print an image based on image data generated by the generation unit. If the first determination unit determines that a print condition of the target page satisfies the predetermined print condition, the setting unit sets a discharge destination of sheets on which images based on pieces of image data of a predetermined number of pages are printed from among the discharge destinations. The print control unit causes the print unit to print the images based on pieces of image data of a predetermined number of pages for which the setting unit has set the discharge destination.

Further features of the present disclosure will become apparent from the following description of exemplary embodiments with reference to the attached drawings.

### BRIEF DESCRIPTION OF THE DRAWINGS

FIG. 1 is a diagram illustrating the configuration of an image forming apparatus according to an embodiment.

FIG. 2 is a block diagram illustrating the configuration of a controller in the image forming apparatus illustrated in FIG. 1.

FIG. 3 is a diagram illustrating the configuration of a sorting unit illustrated in FIG. 1.

FIGS. 4A and 4B are flowcharts illustrating a process according to a first embodiment.

FIG. 5 is a schematic diagram illustrating the order in which sheets are discharged to a tray determined through the process illustrating in FIGS. 4A and 4B.

FIG. 6 is a flowchart illustrating a process according to a second embodiment.

### DESCRIPTION OF THE EMBODIMENTS

Embodiments will be described below with reference to the accompanying drawings. Relative positions and shapes of components in an apparatus according to an embodiment are merely illustrative and are not seen to be limiting.

### First Embodiment

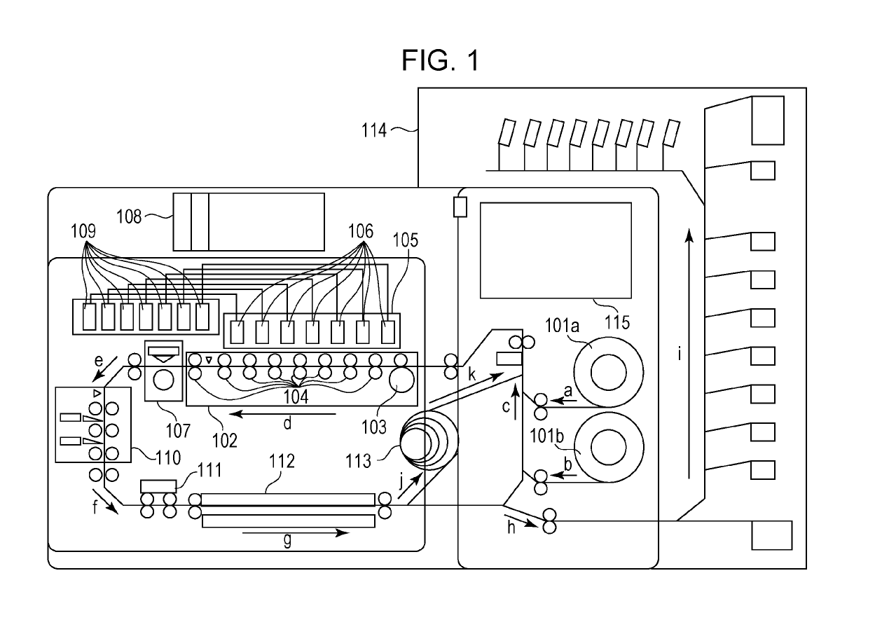

FIG. 1 is a diagram illustrating, in outline, the configuration of an image forming apparatus that is an example of a print control apparatus according to an embodiment. The image forming apparatus illustrated in FIG. 1 has only a printing function. However, the image forming apparatus may further include a reading device for reading an image on a document and function as a copying machine. Alternatively, the image forming apparatus may be configured as a multifunction apparatus having other additional functions. An exemplary case in which a roll sheet is used as a recording material (a recording medium or a recording sheet) to be subjected to print processing will be described. However, the recording material does not necessarily have to be formed into a roll form on the condition that it is a long continuous sheet on the same surface of which a plurality of pages can be continuously printed without a break. The continuous sheet may be automatically cut by the image forming apparatus or may be cut in accordance with an instruction issued by a user manually. The recording material does not have to be paper, and may be any of various materials allowing print processing. The image forming apparatus may be an image forming apparatus capable of performing print processing not only on a continuous sheet but also on a cut sheet of a predetermined size cut in advance. A printing method is not limited to an inkjet printing method using image printing liquid ink to be described later. Solid ink may be used as a recording agent. Any of various printing methods such as the electrophotographic method using toner and the sublimation method may be employed. Color recording in which recording agents of a plurality of colors are used does not necessarily have to be performed, and monochrome recording in which only a recording agent of a black color (including a gray color) is used may be performed. A printed object is not limited to a visible image, and may be an invisible or hardly visible image. Furthermore, a printed object is not limited to an ordinary image, and may be any of various objects such as a wiring pattern, a physical pattern in manufacturing of parts, and a base sequence of deoxyribonucleic acid (DNA). That is, an embodiment can be applied to various types of recording apparatuses capable of applying a recording agent to a recording material. In a case where print processing of the image forming apparatus illustrated in FIG. 1 is controlled in accordance with an instruction transmitted from an external apparatus connected to the image forming apparatus, this external apparatus corresponds to the print control apparatus.

FIG. 1 is a schematic cross-sectional view illustrating the entire configuration of an image forming apparatus using a roll sheet (a continuous sheet longer than the length of a print unit (a page) in a conveyance direction) as a recording material. The image forming apparatus includes the following components 101 to 115. These components are contained in a single housing, but may be contained in a plurality of housings.

A control unit 108 includes a controller (including a central processing unit (CPU) or a micro processing unit (MPU)), an output unit for outputting user interface information (a generator for generating display information and acoustic information), and an input/output (I/O) control unit including various I/O interfaces. The control unit 108 performs various pieces of overall control of the image forming apparatus.

The image forming apparatus includes an upper sheet cassette 101a and a lower sheet cassette 101b as roll units. A user mounts a roll sheet (hereinafter referred to as a sheet) in a magazine and loads the magazine to the sheet cassette 101 (101a and 101b) in the image forming apparatus. A sheet drawn from the upper sheet cassette 101a is conveyed in a direction indicated by an arrow “a” in the drawing. A sheet drawn from the lower sheet cassette 101b is conveyed in a direction indicated by an arrow “b” in the drawing. The sheet drawn from either sheet cassette travels in a direction indicated by an arrow “c” in the drawing and reaches a conveyance unit 102. The conveyance unit 102 conveys the sheet in a direction indicated by an arrow “d” in the drawing (the horizontal direction) using a plurality of rotary rollers 104 during print processing. The switching between the sheet cassettes for supplying a sheet is performed in such a manner that the sheet drawn from one of the sheet cassettes is rewound back into the cassette 101 and a new sheet is supplied from the other one of the sheet cassettes.

Above the conveyance unit 102, a head unit 105 is disposed so as to face the conveyance unit 102. In the head unit 105, a plurality of independent print heads 106 of a plurality of colors (seven in this embodiment) are disposed along the sheet conveyance direction. In this embodiment, the head unit 105 includes seven print heads 106 corresponding one-to-one to seven colors, cyan (C), magenta (M), yellow (Y), light cyan (LC), light magenta (LM), gray (G), and black (K). It should be noted that another color may be used and all of these colors do not necessarily have to be used. The image forming apparatus according to this embodiment causes the print heads 106 to discharge ink in synchronization with sheet conveyance by the conveyance unit 102, thereby forming an image on a sheet. The print heads 106 are disposed at positions where discharge destinations of ink do not overlap the rotary rollers 104. Instead of being directly discharged on a sheet, ink may be applied to an intermediate transfer member and then be applied to a sheet so as to form an image. The conveyance unit 102, the head unit 105, and the print head 106 form a print unit. Ink tanks 109 independently store ink of the respective colors. Ink is supplied from the ink tanks 109 to sub tanks corresponding to the respective colors via tubes, and is supplied from the sub tanks to the respective print heads 106 via tubes. The print heads 106 includes line heads of respective colors (seven colors in this embodiment) arranged along the direction of conveyance during printing indicated by the arrow “d”. Each of the line heads of the respective colors may be formed of a single continuous nozzle chip or divided nozzle chips arranged in a single line or in a regular pattern such as a staggered pattern. Each of the line heads employed in this embodiment is a so-called full multi-head including nozzles arranged in a range covering the width of a print region on a sheet having the maximum size usable by the image forming apparatus. Examples of an inkjet system in which ink is discharged from nozzles include a system using heating elements, a system using piezoelectric elements, a system using electrostatic elements, and a system using microelectromechanical system (MEMS) elements. Ink is discharged from the nozzles of the respective heads based on print data. The timing of the discharge is determined in accordance with a signal output from a conveyance encoder 103. An embodiment is not limited to an inkjet printer that uses ink as a recording agent, and can be applied to various printers such as thermal printers (sublimation printer and thermal transfer printer), dot impact printers, light-emitting diode (LED) printers, and electrophotographic laser printers.

After an image has been formed on a sheet, the sheet is conveyed from the conveyance unit 102 to a scanner unit 107. The scanner unit 107 optically reads a printed image or a special pattern on the sheet so as to check whether there is a problem with the printed image and check the state of the image forming apparatus including an ink discharge state. An image check method according to this embodiment may be a method of reading a head state check pattern printed on a sheet for the purpose of checking the state of discharge of ink or a method of comparing a printed image with an original image for the purpose of checking whether printing has been successfully performed, and can be selected from among various image check methods as appropriate.

The sheet is conveyed from the vicinity of the scanner unit 107 in a direction indicated by an arrow “e”, and is introduced into a cutter unit 110. The cutter unit 110 cuts the sheet into segments of a predetermined unit length. The predetermined unit length is, for example, the image of one page or an impression including a plurality of pages, and varies depending on the size of a printed image. For example, an L-size photograph has a length of 135 mm in the conveyance direction, and an A4-size image has a length of 297 mm in the conveyance direction. At the time of single-sided printing, the cutter unit 110 cuts the sheet in units of pages. However, in some cases, the cutter unit 110 does not cut the sheet in units of pages depending on the content of a print job. At the time of double-sided printing, the cutter unit 110 does not cut a first surface (for example, a front surface) of a sheet in predetermined units of, for example, pages. Images are continuously printed on a sheet having a predetermined length. The cutter unit 110 cuts a second surface (for example, a back surface) of the sheet in units of, for example, pages after the second surface has been subjected to printing.

The cutter unit 110 does not necessarily have to cut a sheet by every image when performing single-sided printing or processing a back surface at the time of double-sided printing. The cutter unit 110 may avoid cutting a sheet until the sheet is conveyed by a predetermined length and cut the sheet after the sheet has been conveyed by the predetermined length. The sheet may be cut by a predetermined unit length (for example, in units of pages) by another cutter device operated manually. In a case where it is necessary to cut the sheet in the width direction, another cutter device is used for cutting the sheet.

The sheet conveyed from the cutter unit 110 travels in the unit in a direction indicated by an arrow “f” illustrated in the drawing, and is conveyed to a back surface print unit 111. The back surface print unit 111 is a unit for printing predetermined information on the back surface of the sheet when an image is printed only on one surface of the sheet. Information printed on the back surface of the sheet includes a character, a mark, and a code corresponding to each printed image (for example, a number for order management). In a case where the print heads 106 print an image for a print job of double-sided printing, the back surface print unit 111 prints the above-described information in a region other than a region where the print heads 106 print the image. The back surface print unit 111 can employ a recording-agent imprinting method, a thermal transfer method, or an inkjet method.

The sheet passed through the back surface print unit 111 is conveyed to a drying unit 112. The drying unit 112 is a unit for heating the sheet traveling in the unit in a direction indicated by an arrow g with hot air (heated gas (air)) for the purpose of drying the sheet applied with ink in a short time. Instead of using hot air, the drying unit 112 may dry the sheet by any of various drying methods such as drying the sheet with cold air, heating the sheet by a heater, leaving the sheet to air-dry, and irradiating the sheet with electromagnetic waves such as ultraviolet light. The sheets into which the sheet has been cut by a unit length pass through the drying unit 112 one by one, travel in a direction indicated by an arrow “h” in the drawing, and are then conveyed to the sorting unit 114. The sorting unit 114 will be described in detail later.

A sheet winding unit 113 winds the sheet on the front surface of which an image is printed and which is not cut by a predetermined unit length (in units of pages in this embodiment). At the time of double-sided printing, the sheet on the front surface of which an image is formed is not cut in units of pages by the cutter unit 110, and a trailing edge of the sheet is cut after completion of image formation on the front surface of the sheet. The sheet on the front surface of which an image is printed travels in the unit in a direction indicated by an arrow “j” in the drawing and is wound by the sheet winding unit 113. After the continuous front surface corresponding to a series of pages has been subjected to image formation and a sheet having the continuous front surface has been wound, the sheet is turned over so that the surface thereof opposite to the front surface becomes a printable surface and is made to face the print heads 106. Then, the sheet is conveyed again in the unit in a direction indicated by an arrow k in the drawing. Such conveyance allows the printing of an image on the back surface opposite to the processed front surface. At the time of normal single-sided printing, a sheet with an image printed thereon is conveyed to the sorting unit 114 without being wound by the sheet winding unit 113.

Thus, at the time of double-sided printing, the sheet is wound using the sheet winding unit 113 and is then turned over for printing on the back surface. Accordingly, the surface of a sheet facing upward when the sheet is discharged into the sorting unit 114 at the time of single-sided printing is different from that at the time of double-sided printing. That is, at the time of single-sided printing, the inversion of a sheet using the sheet winding unit 113 is not performed, and the sheet with the image of the first page printed thereon is discharged in a state in which the surface of the sheet with the first page image printed thereon faces downward. In a case where a plurality of pages are printed by a single print job, the sheet of the first page is discharged onto the tray first. After that, the sheets of the subsequent pages are discharged in order, and are sequentially stacked on the tray. This discharge in which sheets are stacked in ascending order of the page number is called a face-down discharge. In contrast, at the time of double-sided printing, the inversion of a sheet using the sheet winding unit 113 is performed, and the sheet with the image of the first page printed thereon is discharged in a state in which the surface of the sheet with the first page image printed thereon faces upward. In a case where a plurality of pages are printed by a single print job, a sheet including the last page is discharged onto the tray first. After that, sheets are discharged in descending order of the page number, and are sequentially stacked on the tray. Finally, ae sheet including the first page is discharged. This discharge in which sheets are stacked in descending order of the page number is called a face-up discharge.

An operation unit 115 is provided for allowing a user to perform various operations and for informing a user of various pieces of information. With the operation unit 115, a user can check the print condition of each order. For example, the user can check which tray the printed sheet of an image designated by the user is loaded on or check whether the printing of the designated image is being performed or has been completed. In addition, the operation unit 115 allows a user to check various conditions of the apparatus such as the remaining amount of ink and the remaining number of sheets and to make an instruction for maintenance of the apparatus such as head cleaning.

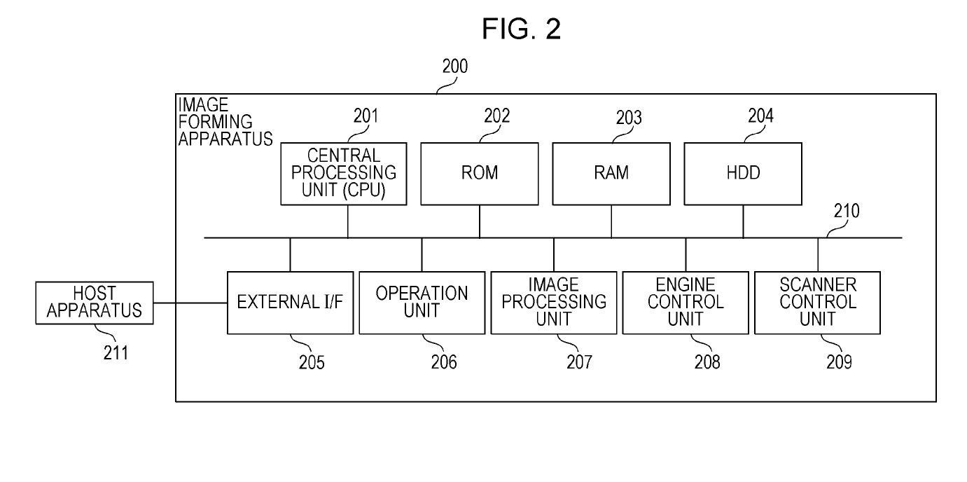

FIG. 2 is a block diagram illustrating the configuration of a controller in the image forming apparatus illustrated in FIG. 1. An image forming apparatus 200 is the image forming apparatus illustrated in FIG. 1.

The control unit 108 includes a central processing unit (CPU) 201, a Read-Only Memory (ROM) 202, a Random Access Memory (RAM) 203, an image processing unit 207, an engine control unit 208, and a scanner control unit 209. A hard disk drive (HDD) 204, an operation unit 206, and an external I/F 205 are connected to the control unit 108 via a system bus 210. The CPU 201 is a central processing unit in the form of a microprocessor (microcomputer), and is included in the control unit 108 in FIG. 1. The CPU 201 performs overall control of the image forming apparatus 200 by executing a program or activating hardware. The ROM 202 stores a program executed by the CPU 201 and fixed data required for various operations of the image forming apparatus 200. The RAM 203 is used as a work area for the CPU 201, is used as a temporary storage area for various pieces of received data, and is used to store various pieces of setting data. The HDD 204 can store a program executed by the CPU 201, print data, and setting information required for various operations of the image forming apparatus 200 in a built-in hard disk, and read them from the built-in hard disk. Instead of the HDD 204, another mass storage device can be used.

The operation unit 206 includes hard keys and a touch panel which allow a user to perform various operations, and a display portion for presenting (informing) various pieces of information to a user. The operation unit 206 corresponds to the operation unit 115 in FIG. 1. The presentation of information to a user can also be performed by outputting sound (such as a buzzer sound or voice) based on sound information generated by an audio generator.

The image processing unit 207 performs various pieces of image processing such as processing for rendering (converting) print data (for example, data expressed by a page description language) in a print job processed in the image forming apparatus 200 into image data (bitmap image data). The image processing unit 207 converts the color space (for example, YCbCr) of image data included in input print data into a standard RGB color space (for example, sRGB), and performs various pieces of image processing such as resolution conversion to an effective number of pixels (printable by the image forming apparatus 200), image analysis, and image correction as needed. Image data obtained as a result of the image processing is stored in the RAM 203 or the HDD 204.

The engine control unit 208 controls processing for printing an image based on print data on a sheet in response to a control command received from the CPU 201. More specifically, the engine control unit 208 inputs an ink discharge instruction to the print heads 106 corresponding to respective colors. Furthermore, the engine control unit 208 sets ink discharge timing to adjust the positions of dots (ink landing positions) on a recording medium. Still furthermore, the engine control unit 208 performs adjustment based on an obtained head driving state. The engine control unit 208 controls the driving of the print heads based on print data, and causes the print heads to eject ink so as to form an image on a sheet. Furthermore, the engine control unit 208 conveys a sheet via an appropriate path at an appropriate speed and stops the conveyance of the sheet by performing conveyance roller control processing including making an instruction for driving a feed roller and an instruction for driving the conveyance roller and acquiring the state of rotation of the conveyance roller.

The scanner control unit 209 controls an image sensor in response to a control command received from the CPU 201, reads an image on a sheet, acquires red (R), green (G), and blue (B) analog brightness data, and converts the analog brightness data into digital data. The image sensor may be, for example, a CCD image sensor or a CMOS image sensor. The image sensor may also be, for example, a linear image sensor or an area image sensor. The scanner control unit 209 makes an instruction for driving the image sensor, acquires the condition of the image sensor driven in response to the instruction, analyzes brightness data acquired from the image sensor, detects whether ink is ejected from the print heads 106, and detects a sheet cut position. When a sheet is determined by the scanner control unit 209 as having an image properly printed thereon, the sheet undergoes processing for drying ink on the sheet and is then discharged to a designated tray in the sorting unit.

The above-described components in the image forming apparatus 200 are connected to each other via the system bus 210 and can communicate with each other.

A host apparatus 211 corresponds to the above-described external apparatus and is connected to the outside of the image forming apparatus 200. The host apparatus 211 serves as a source of supply of image data for causing the image forming apparatus 200 to perform printing, and issues orders of various print jobs. The host apparatus 211 may be a general-purpose personal computer (PC) or a data supply apparatus of another type. Examples of the data supply apparatus of another type include an image capturing apparatus for capturing an image and generating image data. Examples of the image capturing apparatus include a reader (scanner) for reading an image on a document and generating image data and a film scanner for reading a negative film or a positive film and generating image data. Other examples of the image capturing apparatus include a digital camera for capturing a still image and generating digital image data and a digital video camera for capturing a moving image and generating moving image data. It is also possible to provide a photo storage on a network, or provide the image forming apparatus 200 with a socket for allowing insertion of a detachable portable memory. The host apparatus 211 may read an image file from the photo storage or the portable memory, generate image data, and print an image based on the image data. In place of a general-purpose PC, various types of data supply apparatuses such as a terminal dedicated to the image forming apparatus may be used. The data supply apparatus may be a component of the image forming apparatus or may be an independent apparatus externally connected to the image forming apparatus. When the host apparatus 211 is a PC, an operating system (OS), application software for generating image data, and a printer driver for the image forming apparatus 200 are installed in a storage device in the PC. The printer driver controls the image forming apparatus 200. Furthermore, the printer driver converts image data supplied by the application software into a format that can be handled by the image forming apparatus 200 and generates print data. The host apparatus 211 may perform the conversion from the print data to image data and supply the image data to the image forming apparatus 200. All the processes do not necessarily have to be realized using software and may be realized partly or entirely using a piece of hardware. The image data and other commands supplied from the host apparatus 211 and a status signal are exchangeable with the image forming apparatus 200 via the external I/F 205. The external I/F 205 may be a local I/F or a network I/F. The connection to the external I/F 205 may be established in a wired or wireless manner.

In the above-described example, the single CPU 201 controls all the components in the image forming apparatus 200 illustrated in FIG. 2. However, another configuration may also be applicable. That is, a configuration in which some of the functional blocks include corresponding CPUs, and are individually controlled by the corresponding CPUs is also applicable. The above-described functional blocks can employ various functional configurations different from the configuration illustrated in FIG. 2 to execute differently shared functions. More specifically, each functional block described above can be divided into separate processing units or control units. Furthermore, some of the above-described functional blocks can be implemented integrally as one unit. The reading of data from the memory may be performed using a direct memory access controller (DMAC).

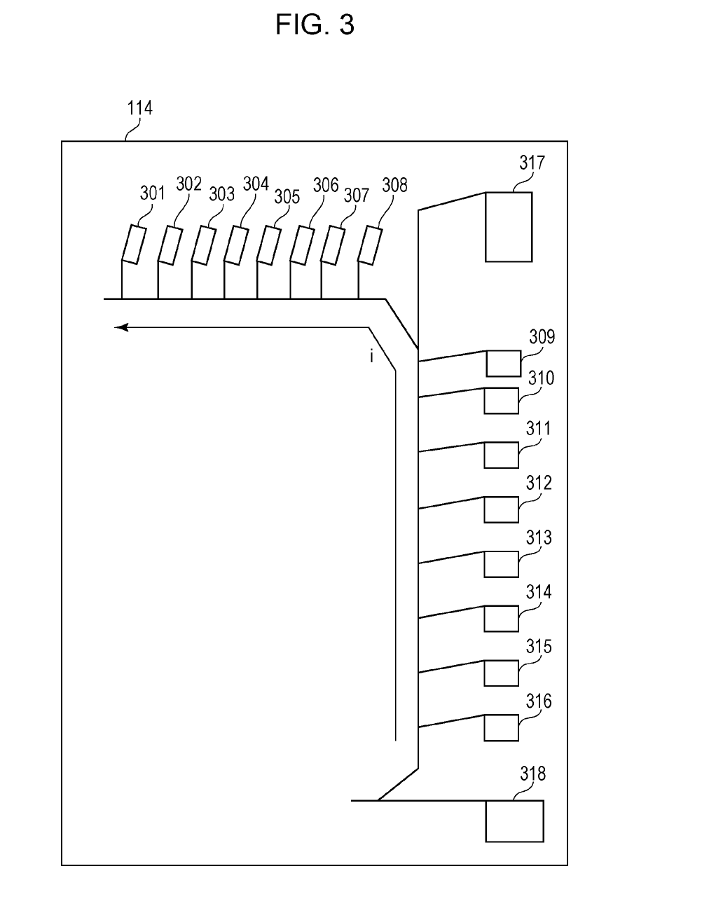

FIG. 3 is a diagram illustrating the configuration of the sorting unit 114. The sorting unit 114 holds a plurality of trays (18 trays in this embodiment), and determines a tray to be a sheet discharge destination in accordance with a print unit length. A tray number is assigned to each tray. The sorting unit 114 discharges a sheet traveling in the unit in a direction indicated by an arrow “i” in the drawing to a tray corresponding to a tray number set for each printed image while checking, by a sensor disposed on the tray, whether the tray is vacant or is full of sheets. The checking of whether each tray is vacant or full and the management of the number of vacant trays in the sorting unit 114 are performed by, for example, the CPU 201. As the tray serving as the discharge destination of a cut sheet, a specific tray is designated by a print job issuing source (host apparatus), or a vacant tray is arbitrarily designated in the image forming apparatus. A predetermined number of sheets are dischargeable to one tray. In the case of a print job for a greater number of sheets than the predetermined number of sheets, sheets are discharged to a plurality of trays. The number of sheets, a sheet size, and a sheet type dischargeable to a tray varies depending on the size (type) of the tray. Referring to FIG. 3, both sheets of a large size (for example, the A4 size) larger than the 2L size and sheets of a small size (equal to or smaller than the 2L size) are dischargeable to trays 309 to 316 (hereinafter referred to as large trays) arranged in the longitudinal (vertical) direction. Sheets of the small size (equal to or smaller than the 2L size) are dischargeable to trays 301 to 308 (hereinafter referred to as small trays) arranged in the lateral (horizontal) direction, but sheets of the large size cannot be discharged to them. A tray 317 (hereinafter referred to as an extra tray) at the uppermost stage of the trays arranged in the longitudinal (vertical) direction is used when the large trays and the small trays are full. A criterion by which to determine whether the extra tray should be used is set for the image forming apparatus by a user, and can be changed as appropriate. A trash tray 318 is provided to which a sheet with a registration adjustment control pattern and a non-discharge complement pattern printed thereon is discharged.

Furthermore, a display device such as a light-emitting diode (LED) is used to allow a user to recognize a sheet discharge state such as an in-progress sheet discharge or the completion of a sheet discharge. For example, a plurality of LEDs that emit light of different colors are disposed at respective trays so as to notify a user of the states of these trays. The user can recognize the various states of each tray by checking which color the LED of the tray lights and whether the LED of the tray simply lights up or blinks.

Priorities can be assigned to these trays. When executing a print job, the image forming apparatus 200 sequentially sets vacant trays (holding no sheet) as sheet discharge destinations in accordance with the priorities. In this embodiment, in a default setting, the large trays are arranged from top to bottom in descending order of priority and the small trays are arranged from the left to the right in descending order of priority. A higher priority is assigned to the small trays than to the large trays. The priority assignment method is not limited to the above-described method. For example, a higher priority may be assigned to a tray at a location where a user can easily remove a sheet. The priorities may be changeable through a user's operation.

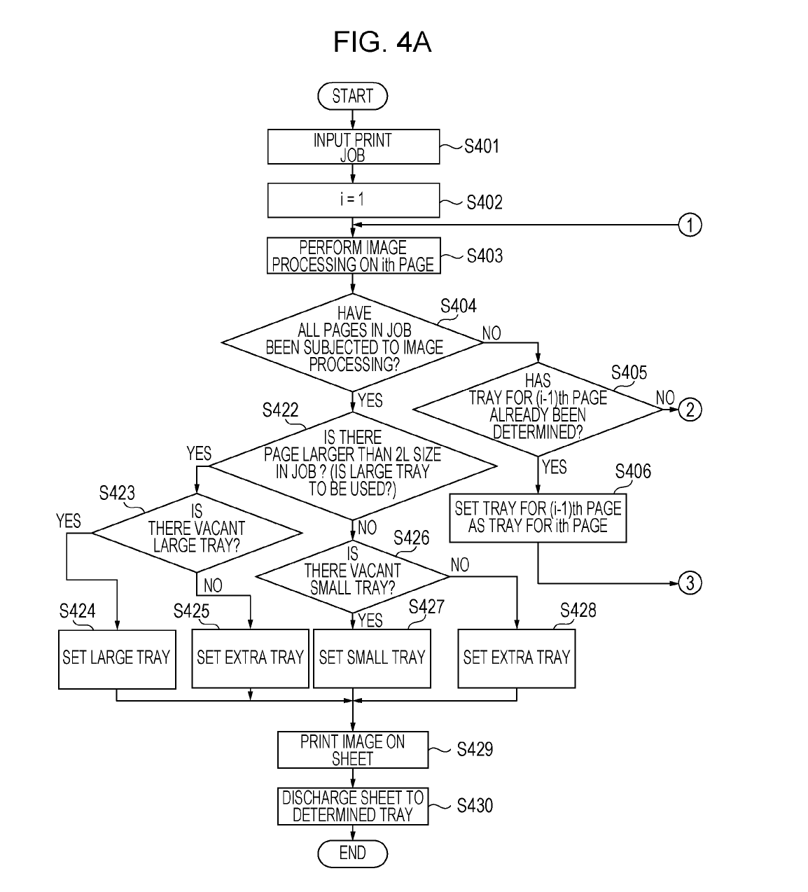

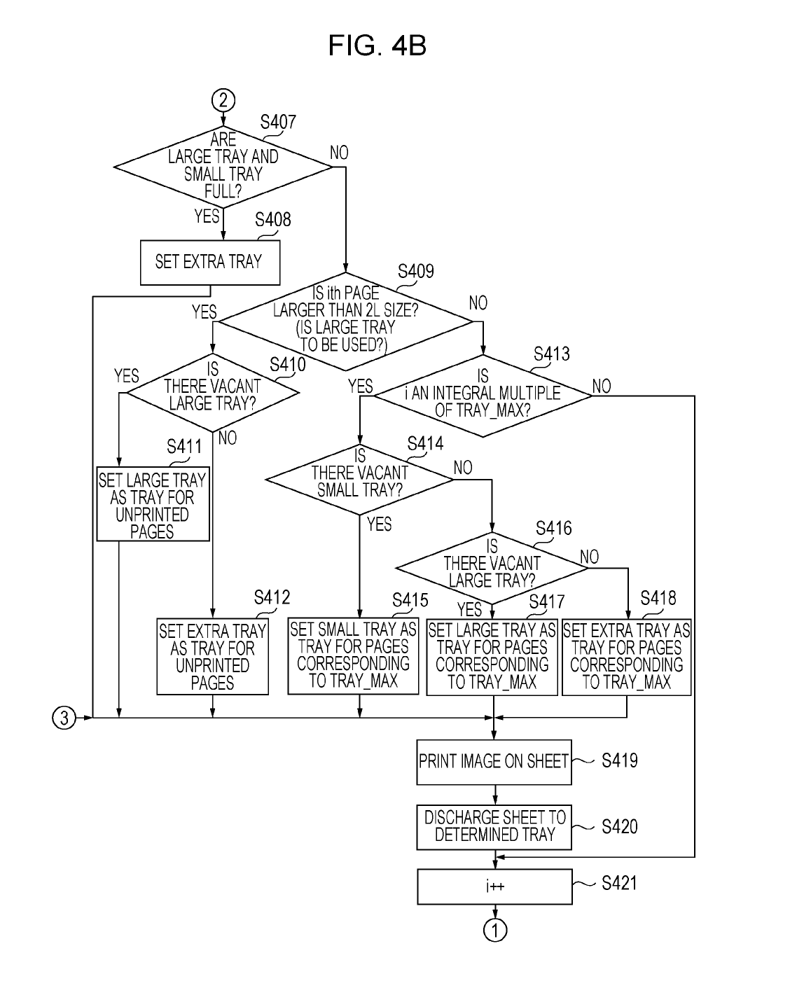

FIGS. 4A and 4B are flowcharts illustrating a process of determining a tray used and performing printing in a case where a print job is received and image processing and printing are performed in parallel. For example, the process illustrated in FIGS. 4A and 4B is performed in such a manner that the CPU 201 reads out a program stored in the ROM 202 to the RAM 203 and executes the program.

In step S401, a print job is input from the host apparatus 211. Information required for printing is also input. The information is, for example, information about a print size, and is added to the print job. A print size may be specified by a user or may be set for the print job in advance.

In step S402, i=1 where i represents a page number in a print job is set as an initial value.

In step S403, the image processing unit 207 performs image processing upon data of an ith page so as to generate image data from print data. That is, the image processing unit 207 generates image data of the ith page.

In step S404, it is determined whether all pages in the print job have been subjected to image processing. When it is determined that all pages have yet to be subjected to image processing (No in step S404), the process proceeds to step S405. It is determined that all pages have been subjected to image processing (Yes in step S404), the process proceeds to step S422.

In step S405, it is determined whether a print sheet discharge tray for an (i−1)th page has already been determined. When it is determined that the print sheet discharge tray for the (i−1)th page has already been determined (Yes in step S405), the process proceeds to step S406 in which the tray for the (i−1)th page is also set as the print sheet discharge tray for the ith page. When it is determined that the print sheet discharge tray for the (i−1)th page has yet to be determined (No in step S405), the process proceeds to step S407.

In step S407, it is determined whether there is a vacant tray. When both the large trays and the small trays are not available (Yes in step S407), the process proceeds to step S408 in which an extra tray is set as the print sheet discharge tray for the ith page. When at least one of the large trays and the small trays is available, that is, there is a vacant tray (No in step S407), the process proceeds to step S409.

In step S409, it is determined whether the print data of the ith page indicates a size larger than the 2L size so as to determine which of the large tray and the small tray in the sorting unit 114 a sheet should be discharged to. This determination is performed based on print size information added to a print job. When the print data of the ith page indicates a size larger than the 2L size (Yes in step S409), the process proceeds to step S410. When the print data of the ith page indicates a size equal to or smaller than the 2L size (No in step S409), the process proceeds to step S413.

In step S410, it is determined whether there is a vacant large tray in the sorting unit 114. When there is a vacant large tray (Yes in step S410), the process proceeds to step S411 in which the print sheet discharge tray for all of unprinted pages among pages to the ith page is set to the large tray. The unprinted pages are pages for which the print sheet discharge tray has yet to be determined. When there is no vacant large tray (No in step S410), the process proceeds to step S412 in which the print sheet discharge tray for all of unprinted pages among pages to the ith page is set to the extra tray. The unprinted pages are pages for which the print sheet discharge tray has yet to be determined.

In step S413, it is determined whether the ith page is an integral multiple of the maximum number of sheets stackable on a tray, that is, the sheet capacity of the tray. The equation of i=TRAY_MAX*N (N=1, 2, 3 . . . ) means that pieces of print data of the maximum number of sheets stackable on a tray have been subjected to image processing. It is therefore determined that print processing can be started, and the process proceeds to step S414. In this embodiment, the maximum numbers of sheets stackable on respective trays are the same. If the maximum number of stackable sheets varies from tray to tray, for example, it may be determined whether the ith page is an integral multiple of the maximum number of stackable sheets smaller than the other maximum numbers of stackable sheet.

In step S414, it is determined whether there is a vacant small tray. When there is a vacant small tray (Yes in step S414), the small tray is set as the print sheet discharge tray for pages corresponding to the maximum number of sheets stackable on each tray in step S415. When there is no vacant small tray (No in step S414), the process proceeds to step S416. In this embodiment, the maximum numbers of stackable sheets on respective trays are the same. In a case where a print job includes pages equal to or larger than the maximum number of stackable sheets, it is necessary to discharge these pages to a plurality of discharge trays. Even in a case of a print job including pages of different sizes or types, when, among these pages, pages corresponding to the maximum number of stackable sheets have a small size, they are discharged to a small tray.

In step S416, it is determined whether there is a vacant large tray. When there is a vacant large tray (Yes in step S416), the large tray is set as the print sheet discharge tray for pages corresponding to the maximum number of sheets stackable on each tray in step S417. When there is no vacant large tray (No in step S416), the extra tray is set as the print sheet discharge tray for pages corresponding to the maximum number of sheets stackable on each tray in step S418.

Thus, when the determination of a discharge tray for the print sheet of each page has been completed, the process proceeds to step S419 in which the image forming apparatus 200 prints an image on each sheet based on image data. In step S420, the image forming apparatus 200 discharges each sheet to the determined tray in the sorting unit 114. In step S421, the page number i is incremented by one. The process returns to step S403 in which image processing is performed upon the next page.

When it is determined in step S413 that i is the integral multiple of the maximum number of sheets stackable on each tray and the process returns to step S403, that is, the process proceeds to step S415, S417, or S418 and returns to step S403, it is determined in step S405 that a print sheet discharge tray for the (i−1)th page has yet to be determined. For example, after steps S415, S417, and S418, a flag may be set. It may be determined in step S405 that the (i−1)th page has not been printed and discharged to a tray when the flag is in an ON state and the process may proceed to step S407. Alternatively, after steps S415, S417, and S418, the value of i may be set to 0. In this case, it is determined in step S413 whether i is equal to the maximum number of sheets stackable on each tray.

When i is not an integral multiple of the maximum number of sheets stackable on each tray in step S413 (No in step S413), printing is not started and the page number i is incremented by one in step S421. The process returns to step S403 in which image processing is performed upon the next page.

Thus, in this embodiment, image processing is performed on data in a job and a discharge tray is determined on a page-by-page basis. At the time of determining a large tray as a discharge tray, printing is started. Accordingly, even in the case of a job including pages of different sizes, these pages can be discharged to the same tray. In addition, as compared with a case where printing is started after all pages have been subjected to image processing, printing can be started earlier and a time taken for printing can be shortened.

In a case where there is no vacant large tray and there is only a vacant small tray or a vacant extra tray, printing is started at the time of generation of print data of the ith page. As a result, a time taken for printing can be shortened.

By starting printing at the time of storage of pieces of print data of the maximum number of sheets dischargeable to a small tray, it is possible to shorten a time taken for printing for a job including only small-sized pages.

In step S422, it is determined whether there is a page larger than the 2L size in a job. In a case where there is more than one page in a job, it is determined whether the ith page, that is, the last page, is larger than the 2L size because pages to the (i−1)th page have already been determined to be equal to or smaller than the 2L size. When there is a page larger than the 2L size, that is, the last page is larger than the 2L size (Yes in step S422), the process proceeds to step S423. When there is no page larger than the 2L size, that is, the last page is equal to or smaller than the 2L size (No in step S422), the process proceeds to step S426.

In step S423, it is determined whether there is a vacant large try. When there is a vacant large try (Yes in step S423), the process proceeds to step S424 in which a print sheet discharge tray for all pages is set to the large tray. When there is no vacant large tray (No in step S423), the process proceeds to step S425 in which a print sheet discharge tray for all pages is set to the extra tray.

In step S426, it is determined whether there is a vacant small tray. When there is a vacant small tray (Yes in step S426), a print sheet discharge tray for all pages is set to the small tray in step S427. When there is no vacant small tray (No in step S426), the process proceeds to step S428 in which a print sheet discharge tray for all pages is set to the extra tray.

Thus, when the determination of a print sheet discharge tray for each page has been completed, the process proceeds to step S429 in which the image forming apparatus 200 prints an image on each sheet based on image data. In step S430, the image forming apparatus 200 discharges each sheet to the determined tray in the sorting unit 114.

As described previously, in a case where image processing on data in a job is completed and printing is not started, a tray for all pages is determined based on the last page and these pages are discharged to the determined same tray.

In this embodiment, an extra tray is used when there is no vacant large tray or no vacant small tray. However, for example, in a case where the use of the extra tray is inhibited in the setting of the extra tray, the extra tray may be brought into a tray full state without being used.

A tray used is determined based on a sheet size in this embodiment, but may be determined based on the type or basis weight of a sheet.

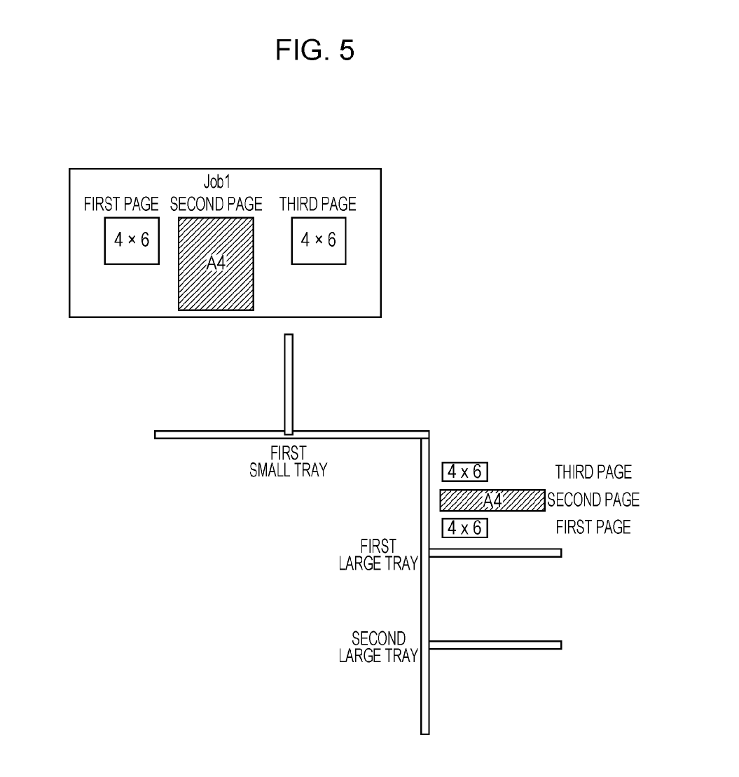

FIG. 5 is a schematic diagram illustrating the order in which sheets are discharged to a tray determined through the process illustrating in FIGS. 4A and 4B.

Data of a job including the first page of 4×6 inch, the second page of the A4 size, and the third page of 4×6 inch is used. A case where image processing is performed upon this job and printing is performed will be described. Descriptions will be made on the assumption that there are a vacant large tray and a vacant small tray. Since, after image processing has been performed upon the first page, it is determined that the first page is smaller than the 2L size and the maximum number of sheets stackable on each tray is not reached, the determination of a tray is not performed and printing is not started (No in step S405, No in step S407, No in step S409, and No in step S413). Since, after image processing has been performed upon the second page, the second page is determined to be larger than the 2L size, a discharge tray for the second page is set to a large tray (No in step S405, No in step S407, Yes in step S409, Yes in step S410, and step S411). At the same time, a discharge tray for the first mage is also set to the large tray (step S411). At that time, the printing of the first page and the second page is started and these pages are discharged to a first large tray. Subsequently, image processing is performed upon the third page. Since the second page has been discharged to the large tray, the large tray for the second page is also set as a discharge tray for the third page and the third page is printed and is then discharged to the tray (Yes in step S405). As a result, all the pages are discharged to the first large tray. It may be determined which of large trays is set as a discharge tray in accordance with the priorities set in advance.

As described previously, in this embodiment, sheets of different sizes or types included in a single print job can be discharged to the same tray. Pages can be prevented from being discharged to different discharge trays out of order. Image processing is performed on a page-by-page basis. At the time when a large tray is determined as a page discharge tray, printing is started. Accordingly, as compared with a case where printing is started after all pages have been subjected to image processing, printing can be started earlier and a time taken for printing can be shortened. In a case where there is no vacant large tray and there is only a vacant small tray or a vacant extra tray, printing is started at the time of generation of print data of the ith page. Accordingly, as compared with a case where printing is started after all pages have been subjected to image processing, printing can be started earlier and a time taken for printing can be shortened. Printing is started at the time of storage of pieces of print data of the maximum number of sheets dischargeable to a small tray. Accordingly, as compared with a case where printing is started after all pages have been subjected to image processing, printing can be started earlier and a time taken for printing for a job including only small-sized pages can be shortened.

That is, according to this embodiment, even in the case of a job in which different print conditions are mixed, sheets can be discharged to the same tray and printing can be started earlier. Accordingly, a sorting workload on a user can be reduced and a time taken for printing can be shortened.

### Second Embodiment

In this embodiment, a discharge tray for a printed sheet is determined in accordance with the priority of a print job. The same reference numerals are used to identify parts already described in the first embodiment, and the description thereof will be therefore omitted.

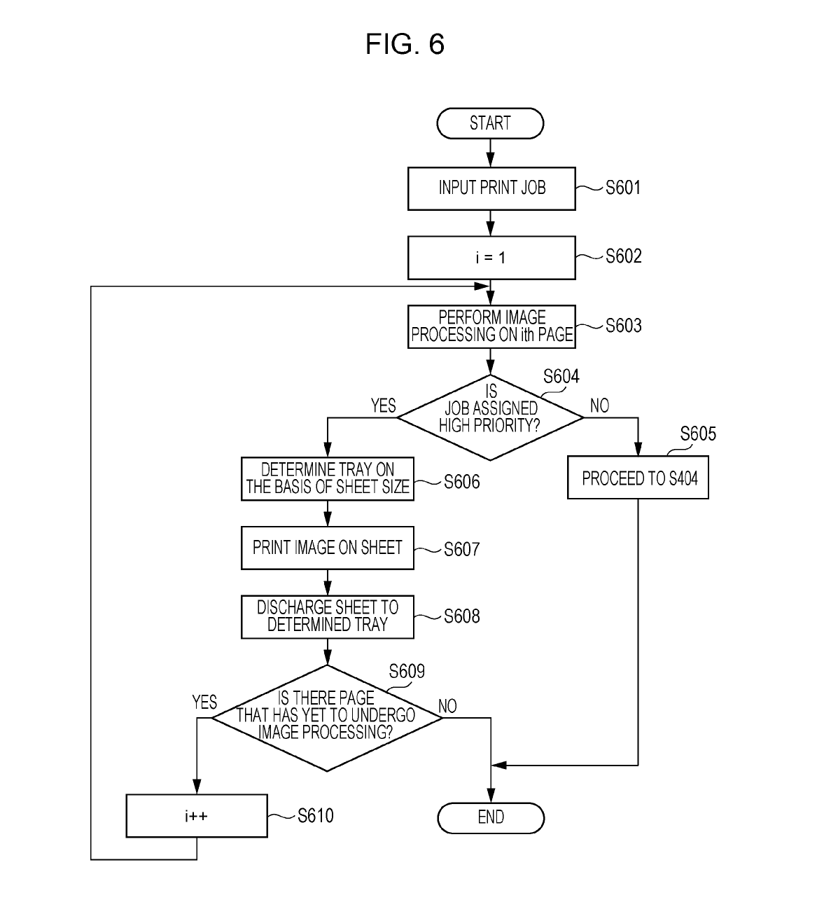

FIG. 6 is a flowchart illustrating a process of determining a tray used and performing printing in a case where image processing and printing are performed in parallel in accordance with the priority of a print job. For example, the process illustrated in FIG. 6 is performed in such a manner that the CPU 201 reads out a program stored in the ROM 202 to the RAM 203 and executes the program.

In step S601, a print job is input from the host apparatus 211. Information required for printing is also input. The information is, for example, information about a print size, and is added to the print job.

In step S602, i=1 where i represents a page number in a print job is set as an initial value.

In step S603, the image processing unit 207 performs image processing upon data of an ith page so as to generate print data.

In step S604, it is determined whether the priority of the job is high. For example, a job for interrupt printing is determined to have a high priority. When a priority is not high (No in step S604), the process proceeds to step S605 in which the process proceeds to step S404 illustrated in FIG. 4A. Subsequently, the process illustrating in FIGS. 4A and 4B is performed. When it is determined that the job has a high priority (Yes in step S604), the process proceeds to step S606.

In step S606, a tray used for the page is determined in accordance with a sheet size. The processing of step S606 is similar to the tray determination process from step S422 to step S428 in FIG. 4A, and the description thereof will be therefore omitted. In step S422, it is determined whether the page is larger than the 2L size.

The image forming apparatus 200 prints an image on the sheet in step S607 and discharges the sheet to a determined tray in the sorting unit 114 in step S608. In step S610, i is incremented by one. The process returns to step S603 in which image processing is performed upon the next page.

As described previously, in this embodiment, a print job with a high priority can be printed as early as possible. That is, in the case of a print job with a high priority, printing can be started at the time of generation of print data of a first page that has been subjected to image processing.

In the case of print jobs other than a print job with a high priority, for example, normal print jobs, effects similar to those described in the first embodiment can be obtained.

That is, according to this embodiment, even in the case of a job in which different print conditions are mixed, sheets can be discharged to the same tray and printing can be started earlier. Accordingly, a sorting workload on a user can be reduced and a time taken for printing can be shortened.

### Other Embodiments

The above-described embodiments are not seen to be limiting. In the above-described embodiments, in order to start printing earlier, image processing is performed on a page-by-page basis and the determination processing of step S404 is performed. However, the determination processing of step S404 may be performed each time a print job is processed in a predetermined unit, for example, each time image processing on a plurality of pages is completed. In this case, the pieces of determination processing of steps S403, S407, and S409 are performed not only on the ith page but on a plurality of pages including the ith page. It is therefore possible to reduce a determination workload and start printing earlier as compared with a case where printing is started after image processing has been performed upon all pages.

In the above-described embodiments, in steps S409 and S422, it is determined whether a target page is larger than the 2L size. Based on a result of this determination, a discharge tray for the target page is determined. However, for example, it may be determined whether a target page is larger than another size (for example, the A4 size) or a print sheet is a specific type of sheet (for example, a glossy sheet). Alternatively, both of them may be determined. In these cases, in steps S409 and S422, it may be determined whether a target page satisfies a predetermined print condition.

In the above-described embodiments, as print sheet discharge destinations, large trays, small trays, and an extra tray are provided. However, a medium tray may be provided in addition to them or the extra tray does not necessarily have to be provided.

In the above-described embodiments described with reference to FIGS. 3 to 6, a roll sheet is used. However, a recording medium is not limited to a continuous sheet and may be a cut sheet of a predetermined size cut in advance.

In the above-described embodiments, each time print data is generated as a result of image processing, printing is performed. However, an image forming apparatus according to an embodiment may perform printing after all pieces of print data in a print job have been generated. That is, the image forming apparatus may be configured so that it can select the so-called on-the-fly mode in which printing is performed each time print data of each page is generated or a mode in which printing is performed after all pieces of print data in a print job have been generated. In a case where the mode in which printing is performed after all pieces of print data in a print job have been generated is selected, the process returns to step S402 in the case of No in step S404, that is, until the completion of image processing on all pages in the print job. In the case of Yes in step S404, the process from steps S422 to S430 is performed.

Additional embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-190117, filed Sep. 18, 2014, which is hereby incorporated by reference herein in its entirety.

What is claimed is:

1. A print control apparatus comprising:
a generation unit configured to generate pieces of image data based on pieces of print data of a plurality of pages;
a first determination unit configured to, each time the generation unit generates image data of a target page based on print data of the target page, determine whether a print condition of the target page satisfies a predetermined print condition;
a setting unit configured to, based on a result of the determination performed by the first determination unit, set a discharge destination of sheets on which images based on pieces of image data of a predetermined number of pages including the target page are printed from among discharge destinations; and
a print control unit configured to cause a print unit to print an image based on image data generated by the generation unit,
wherein, if the first determination unit determines that a print condition of the target page satisfies the predetermined print condition, the setting unit sets a discharge destination of sheets on which images based on pieces of image data of a predetermined number of pages are printed from among the discharge destinations, and
wherein the print control unit causes the print unit to print the images based on pieces of image data of a predetermined number of pages for which the setting unit has set the discharge destination.

2. The print control apparatus according to claim 1, further comprising a second determination unit configured to determine whether a discharge destination of a sheet on which an image based on image data of a page previous to the target page is printed has already been determined,
wherein, if the second determination unit determines that the discharge destination has already been determined, the setting unit sets the discharge destination of a sheet on which an image based on image data of a page previous to the target page is printed as a discharge destination of the target page.

3. The print control apparatus according to claim 1, wherein the predetermined number of pages include a page that is previous to the target page and whose discharge destination is not yet determined.

4. The print control apparatus according to claim 1, further comprising a third determination unit configured to determine whether a sheet capacity of a discharge destination is reached in a case where pages to the target page are printed and discharged,
wherein, if the first determination unit determines that the predetermined print condition is not satisfied and the third determination unit determines that the sheet capacity is reached, the setting unit sets the discharge destination of sheets on which images based on pieces of image data of the predetermined number of pages are printed.

5. The print control apparatus according to claim 1, wherein, if the first determination unit determines that the predetermined print condition is not satisfied and the generation unit generates pieces of image data of all pages in a print job, the setting unit sets the discharge destination of sheets on which images based on pieces of image data of the predetermined number of pages are printed.

6. The print control apparatus according to claim 1, wherein the predetermined print condition is a specific print size.

7. The print control apparatus according to claim 1, further comprising a specifying unit configured to specify a vacancy state of the discharge destinations,
wherein, based on a result of determination performed by the first determination unit and a vacancy state specified by the specifying unit, the setting unit sets the discharge destination of sheets on which images based on pieces of image data of the predetermined number of pages are printed from among the discharge destinations.

8. The print control apparatus according to claim 1, wherein, if a priority of a print job is higher than that of other print jobs, the setting unit sets a discharge destination of a sheet on which an image based on image data of the target page is printed from among the discharge destinations even in a case where the first determination unit determines that the predetermined print condition is not satisfied.

9. A print control method comprising:
generating pieces of image data based on pieces of print data of a plurality of pages;
determining, each time image data of a target page is generated based on print data of the target page, whether a print condition of the target page satisfies a predetermined print condition;
setting, based on a result of the determination, a discharge destination of sheets on which images based on pieces of image data of a predetermined number of pages including the target page are printed from among discharge destinations; and
causing a print unit to print an image based on generated image data,
wherein, if it is determined that a print condition of the target page satisfies the predetermined print condition, a discharge destination of sheets on which images based on pieces of image data of a predetermined number of pages are printed is set from among the discharge destinations, and
wherein the print unit prints the images based on pieces of image data of a predetermined number of pages for which the discharge destination has been set.

10. The print control method according to claim 9, further comprising determining whether a discharge destination of a sheet on which an image based on image data of a page previous to the target page is printed has already been determined,
wherein, if it is determined that the discharge destination has already been determined, the discharge destination of a sheet on which an image based on image data of a page previous to the target page is printed is set as a discharge destination of the target page.

11. The print control method according to claim 9, wherein the predetermined number of pages include a page that is previous to the target page and whose discharge destination is not yet determined.

12. The print control method according to claim 9, further comprising determining whether a sheet capacity of a discharge destination is reached in a case where pages to the target page are printed and discharged,
wherein, if it is determined that the predetermined print condition is not satisfied and it is determined that the sheet capacity is reached, the discharge destination of sheets on which images based on pieces of image data of the predetermined number of pages are printed is set.

13. The print control method according to claim 9, wherein, if it is determined that the predetermined print condition is not satisfied and pieces of image data of all pages in a print job are generated, the discharge destination of sheets on which images based on pieces of image data of the predetermined number of pages are printed is set.

14. The print control method according to claim 9, wherein the predetermined print condition is a specific print size.

15. The print control method according to claim 9, further comprising specifying a vacancy state of the discharge destinations,
wherein, based on a result of determination and a vacancy state specified by the specifying unit, the discharge destination of sheets on which images based on pieces of image data of the predetermined number of pages are printed is set from among the discharge destinations.

16. The print control method according to claim 9, wherein, if a priority of a print job is higher than that of other print jobs, a discharge destination of a sheet on which an image based on image data of the target page is printed is set from among the discharge destinations even in a case where the first determination unit determines that the predetermined print condition is not satisfied.

17. A non-transitory computer-readable storage medium storing computer executable instructions for causing a computer to execute a print control method, the print control method comprising:
generating pieces of image data based on pieces of print data of a plurality of pages;
determining, each time image data of a target page is generated based on print data of the target page, whether a print condition of the target page satisfies a predetermined print condition;
setting, based on a result of the determination, a discharge destination of sheets on which images based on pieces of image data of a predetermined number of pages including the target page are printed from among discharge destinations; and
causing a print unit to print an image based on generated image data,
wherein, if it is determined that a print condition of the target page satisfies the predetermined print condition, a discharge destination of sheets on which images based on pieces of image data of a predetermined number of pages are printed is set from among the discharge destinations, and
wherein the print unit prints the images based on pieces of image data of a predetermined number of pages for which the discharge destination has been set.
